(19) United States
(12) Patent Application Publication
(10) Pub. No.: US 2018/0353911 A1
(43) Pub. Date: Dec. 13, 2018

(54) GAS SOLUTION PRODUCTION APPARATUS

(71) Applicant: Ebara Corporation, Tokyo (JP)

(72) Inventor: Yoichi NAKAGAWA, Tokyo (JP)

(21) Appl. No.: 16/003,215

(22) Filed: Jun. 8, 2018

(30) Foreign Application Priority Data
Jun. 12, 2017 (JP) 2017-115005

(51) Int. Cl. B01F 3/04; B01F 5/04; B01F 3/22

(52) U.S. Cl. CPC B01F 3/04758; B01F 5/0498; B01F 3/2223; B01F 2003/04886; B01F 2215/0096; B01F 2215/008; B01F 5/0471

(57) ABSTRACT

A gas solution production apparatus 1 includes a gas dissolving unit 5 that dissolves the gas of the second raw material into the liquid of the first raw material to generate a gas solution with a predetermined concentration, and a gas-liquid separation unit 8 that subjects the gas solution to gas-liquid separation into a supply liquid and an exhaust gas. The unit 5 includes a first nozzle 9 that atomizes the liquid of the first raw material, a mist mixing section 11 that mixes the liquid of the first raw material atomized by the nozzle 9 and the gas of the second raw material to generate a gas solution with a higher concentration than a predetermined concentration, and a liquid mixing section 12 that mixes the gas solution with the high concentration and the liquid of the first raw material to generate the gas solution with the predetermined concentration.

### BACKGROUND OF THE INVENTION

### Field of the Invention

The present invention relates to a gas solution production apparatus that mixes a liquid of a first raw material and gas of a second raw material to produce a supply liquid.

### Description of the Related Art

in recent years, cleaning of products in a semiconductor device plant, a manufacturing plant of liquid crystal electronic components, and the like has become more and more advanced with complication of manufacturing processes and miniaturization of circuit patterns. For example, fine particles, metals, organic matters and the like that adhere to silicon wafers are removed by using a special liquid (called a cleaning liquid) obtained by dissolving high-purity gas or high-purity gas and a chemical into functional water (ultrapure water or the like), for example.

As a cleaning processing method, a “single-wafer processing method” that performs chemical cleaning and ultrapure water cleaning for each wafer is adopted in response to products of high-mix low-volume production, besides a “batch processing method” that repeats dipping and cleaning operations of a plurality of silicon wafers simultaneously. In the single-wafer processing method, a cleaning step time period (a cycle time) per wafer is longer, and a use amount of the cleaning liquid is larger, as compared with those in the batch processing method, so that reduction in cycle time and reduction in the use amount of the cleaning liquid are required. Currently, in order to achieve effective cleaning in a short time period and reduce the use amount of the cleaning liquid, a high-level cleaning process that switches the cleaning step in a short time period is carried out by using a plurality of functional waters and chemicals individually or simultaneously.

As the functional water, ozone water obtained by dissolving ozone gas into ultrapure water is used. Ozone water is generally produced by an ozone water production apparatus. With advancement and complication of the cleaning process, supply and stop of ozone water to the cleaning apparatus in a short time period are required, but once production of ozone water is stopped in the conventional apparatus, a fixed time period (startup time period) is required until supply of ozone water at a required ozone concentration and a required flow rate is enabled again. Therefore, in order to respond to a supply request of ozone water to the cleaning apparatus, there is proposed an ozone water production apparatus that can produce ozone water in an amount required at a use point (refer to Japanese Patent Laid-Open No. 2016-64386, for example). In the conventional ozone water production apparatus, as a mixer that mixes water and ozone gas to generate ozone water, one that mixes water and gas by using the Venturi effect (for example, an aspirator, an ejector or the like) is used.

However, in the conventional gas solution production apparatus, a dissolution efficiency at a time of dissolving ozone into water is not specially taken into consideration, and further enhancement of the dissolution efficiency at the time of dissolving ozone into water is required.

The present invention is made in the light of the above described problem, and an object of the present invention is to provide a gas solution production apparatus that can enhance a dissolution efficiency at a time of dissolving gas of a second raw material into a liquid of a first raw material.

### SUMMARY OF THE INVENTION

A gas solution production apparatus of the present invention includes a gas dissolving unit that dissolves a gas of a second raw material into a liquid of a first raw material to generate a gas solution with a predetermined concentration, and a gas-liquid separation unit that subjects the gas solution generated by the gas dissolving unit to gas-liquid separation into a supply liquid that is supplied to a use point, and an exhaust gas that is discharged from an exhaust port, wherein the gas dissolving unit includes a first nozzle that atomizes the liquid of the first raw material, a mist mixing section that mixes the liquid of the first raw material which is atomized by the first nozzle and the gas of the second raw material, and generates a gas solution with a higher concentration than the predetermined concentration, and a liquid mixing section that mixes the gas solution with a high concentration generated by the mist mixing section and the liquid of the first raw material, and generates the gas solution with the predetermined concentration.

According to the configuration, when the gas solution is generated by dissolving the gas of the second raw material into the liquid of the first raw material, the liquid of the first raw material is atomized (atomized into fine particles in a mist form) and is mixed with the gas of the second raw material. Thereby, the dissolution efficiency at the time of dissolving the gas of the second raw material into the liquid of the first raw material can be enhanced, and generation of the gas solution can be efficiently performed.

Further, in the gas solution production apparatus of the present invention, the gas dissolving section may include a second nozzle that rectifies the gas of the second raw material to supply the gas of the second raw material to the mist mixing section, and in the mist mixing section, the liquid of the first raw material which is atomized by the first nozzle, and the gas of the second raw material which is rectified by the second nozzle may be mixed, and the gas solution with the high concentration may be generated.

According to the configuration, when the gas of the second raw material is dissolved into the liquid of the first raw material which is atomized to generate the gas solution, the gas of the second raw material is rectified and is mixed with the liquid of the first raw material (the liquid of the first raw material which is atomized). Thereby, the dissolution efficiency at the time of the gas of the second raw material being dissolved into the liquid of the first raw material can be enhanced, and generation of the gas solution can be efficiently performed.

Further, in the gas solution production apparatus of the present invention, in the mist mixing section, the first nozzle and the second nozzle may be disposed to face each other.

According to the configuration, the liquid of the first raw material (the liquid of the first raw material which is atomized) and the gas of the second raw material are supplied from the first nozzle and the second nozzle which are disposed to face each other, so that the liquid of the first raw material (the liquid of the first raw material which is atomized) and the gas of the second raw material are efficiently mixed. Thereby, the dissolution efficiency at the time of the gas of the second raw material being dissolved in the liquid of the first raw material can be enhanced, and generation of the gas solution can be efficiently performed.

Further, in the gas solution production apparatus of the present invention, the mist mixing section may include a connection section having an opening, the gas solution generated in the mist mixing section may be supplied to the liquid mixing section via the opening, and a diameter of the opening may be 10 mm or less.

According to the configuration, the gas solution generated in the mist mixing section is supplied to the liquid mixing section via the opening of the connection section. In this case, the diameter of the opening of the connection section is 10 mm or less, so that the gas solution which is supplied to the liquid mixing section hardly flows back to the mist mixing section from the liquid mixing section via the opening of the connection section. Thereby, the gas solution which is supplied to the liquid mixing section can be prevented from flowing back to the mist mixing section from the liquid mixing section.

In the gas solution production apparatus of the present invention, the connection section may have a shape in which a diameter gradually becomes smaller toward the opening.

According to the configuration, the connection section has the shape (a funnel shape) in which the diameter gradually becomes smaller toward the opening, so that the gas solution which is supplied to the liquid mixing section hardly flows back to the mist mixing section from the liquid mixing section via the connection section (the diameter gradually becomes larger as seen from the opening). Thereby, the gas solution which is supplied to the liquid mixing section can be prevented from flowing back to the mist mixing section from the liquid mixing section.

Further, in the gas solution production apparatus of the present invention, pressures of the liquid of the first raw material and the gas of the second raw material that are supplied to the mist mixing section may be set to be higher than a pressure of the liquid of the first raw material that is supplied to the liquid mixing section.

According to the configuration, the pressure inside the mist mixing section (the pressures of the liquid of the first raw material and the gas of the second raw material which are supplied to the mist mixing section) is higher than the pressure inside the liquid mixing section (the pressure of the liquid of the first raw material which is supplied to the liquid mixing section), so that backflow to the mist mixing section from the liquid mixing section hardly occurs. Thereby, the gas solution which is supplied to the liquid mixing section can be prevented from flowing back to the mist mixing section from the liquid mixing section.

Further, in the gas solution production apparatus of the present invention, the liquid of the first raw material may be pure water or sulfuric acid, and the gas of the second raw material may be any one of ozone, hydrogen, nitrogen, carbon dioxide, oxygen, argon, and xenon, or a gas composed of a combination of ozone, hydrogen, nitrogen, carbon dioxide, oxygen, argon and xenon.

According to the present invention, the dissolution efficiency at the time of dissolving the gas of the second raw material into the liquid of the first raw material can be efficiently enhanced.

### BRIEF DESCRIPTION OF THE DRAWINGS

FIG. 1 is a block diagram illustrating a configuration of a gas solution production apparatus in an embodiment of the present invention;

FIG. 2 is an explanatory view illustrating a configuration of a gas dissolving unit in the embodiment of the present invention;

FIG. 3 is a flowchart for explaining an operation at a time of apparatus start/stop in the embodiment of the present invention;

FIG. 4 is a flowchart explaining an operation at a time of ozone concentration adjustment time in the embodiment of the present invention; and

FIG. 5 is a flowchart for explaining an operation at a time of ozone water flow rate adjustment in the embodiment of the present invention.

### DETAILED DESCRIPTION OF THE PREFERRED EMBODIMENTS

Hereinafter, a gas solution production apparatus of an embodiment of the present invention will be described with use of the drawings. In the present embodiment, a case of an ozone water production apparatus for use in cleaning of semiconductor devices, liquid crystal electronic components, and the like will be illustrated.

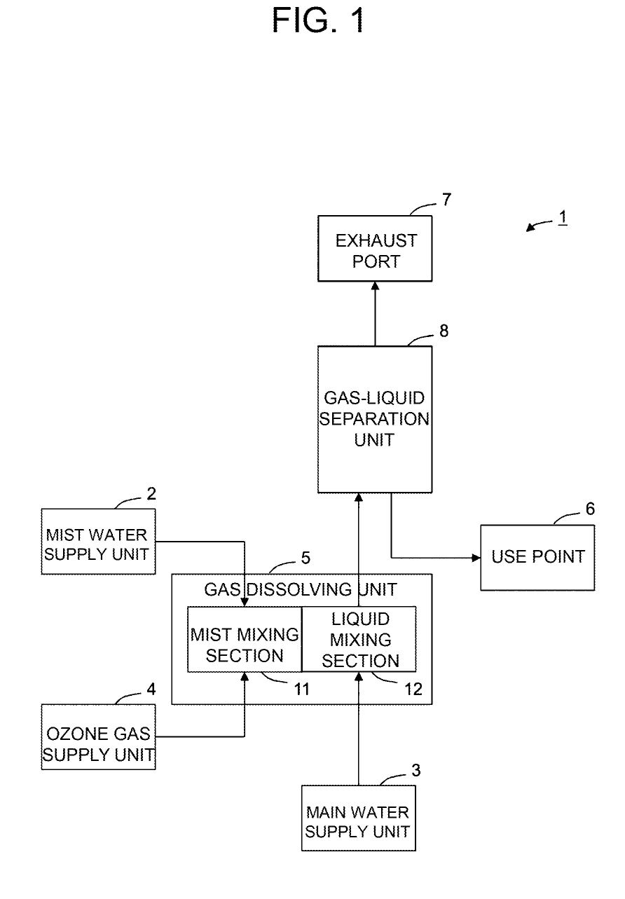

A configuration of the gas solution production apparatus of the embodiment of the present invention will be described with reference to the drawings. FIG. 1 is a block diagram illustrating the configuration of the gas solution production apparatus of the present embodiment. As illustrated in FIG. 1, a gas solution production apparatus 1 includes a mist water supply unit 2 and a main water supply unit 3 that are supply sources of a liquid (pure water) of a first raw material, an ozone gas supply unit 4 that is a supply source of gas (ozone gas) of a second raw material, and a gas dissolving unit 5 that dissolves the gas (ozone gas) of the second raw material into the liquid (pure water) of the first raw material to generate a gas solution (ozone water) with a predetermined concentration. Further, the gas solution production apparatus 1 includes a gas-liquid separation unit 8 that subjects the gas solution generated by the gas dissolving unit 5 to gas-liquid separation into a supply liquid (ozone water) that is supplied to a use point 6, and an exhaust gas (emission gas) that is discharged from an exhaust port 7.

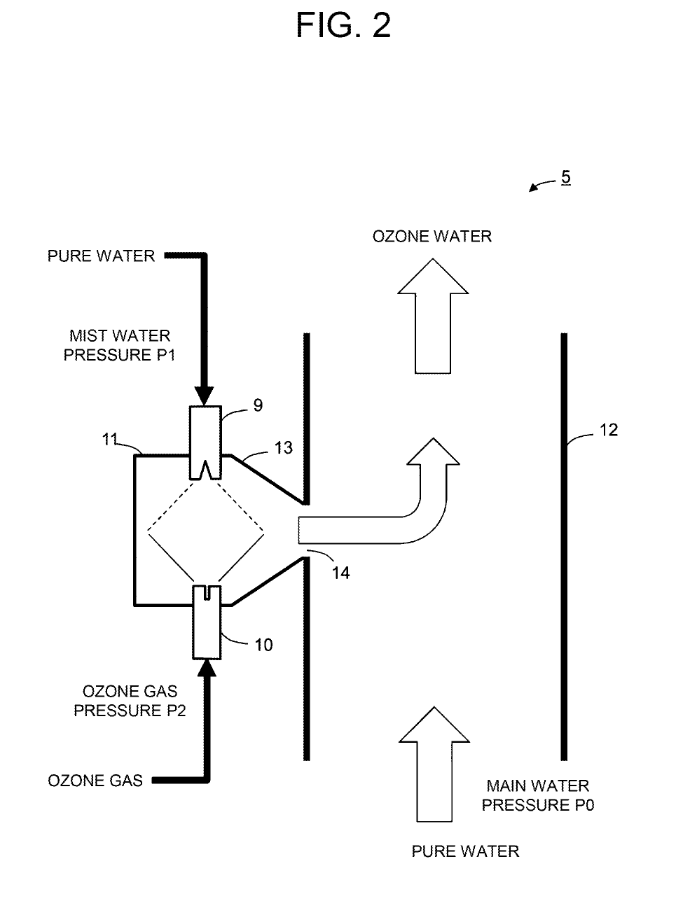

FIG. 2 is an explanatory view illustrating a configuration of the gas dissolving unit 5 that is a feature of the present invention. As illustrated in FIG. 2, the gas dissolving unit 5 includes a first nozzle 9 that atomizes pure water supplied from the mist water supply unit 2, a second nozzle 10 that rectifies ozone gas supplied from the ozone gas supply unit 4, and a mist mixing section 11 that mixes the pure water atomized by the first nozzle 9 and the ozone gas that is rectified by the second nozzle 10 and generates ozone water with a higher concentration than a predetermined concentration. In the mist mixing section 11, the first nozzle 9 and the second nozzle 10 are disposed to face each other. Further, the gas dissolving unit 5 includes a liquid mixing section 12 that mixes the ozone water with the high concentration generated by the mist mixing section 11 and the pure water supplied from the main water supply unit 3 to generate the gas solution with the predetermined concentration. The mist mixing section 11 is configured by a chamber, for example, and the liquid mixing section 12 is configured by a pipe, for example.

Further, as illustrated in FIG. 2, the mist mixing section 11 is connected to the liquid mixing section 12 via a connection section 13. The connection section 13 has a circular opening 14, and ozone water generated in the mist mixing section 11 is configured to be supplied to the liquid mixing section 12 via the opening 14. A diameter of the opening 14 is 10 mm or less. The connection section 13 has a shape (a funnel shape) in which a diameter gradually becomes smaller toward the opening 14. Further, in the present embodiment, a pressure P1 of the pure water which is supplied to the mist mixing section 11 and a pressure P2 of the ozone gas are set to be higher than a pressure P0 of the pure water which is supplied to the liquid mixing section 12 (P1≈P2>P0).

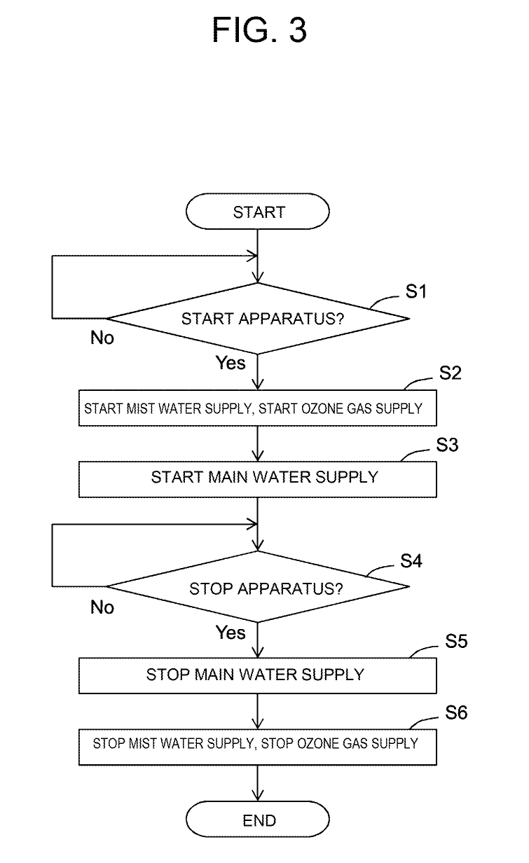

In the gas solution production apparatus 1 of the present embodiment, in order to keep the pressure P1 of the pure water which is supplied to the mist mixing section 11 and the pressure P2 of the ozone gas higher than the pressure P0 of the pure water which is supplied to the liquid mixing section 12, various kinds of control are performed. An operation thereof will be described hereinafter with reference to flowcharts in FIG. 3 to FIG. 5.

FIG. 3 is a flowchart explaining an operation at a time of starting or stopping the gas solution production apparatus 1 of the present embodiment. As illustrated in FIG. 3, when a starting operation of the apparatus is performed in the gas solution production apparatus 1 (S1), supply of the pure water from the mist water supply unit 2 is started at the pressure P1, while supply of the ozone gas from the ozone gas supply unit 4 is started at the pressure P2 (S2), and thereafter, supply of the pure water from the main water supply unit 3 is started at the pressure P0 (S3). When a stopping operation of the apparatus is performed (S4), supply of the pure water from the main water supply unit 3 is stopped (55), after which, supply of the pure water from the mist water supply unit 2 is stopped, and supply of the ozone gas from the ozone gas supply unit 4 is stopped (S6). In this way, the pressure P1 of the pure water which is supplied to the mist mixing section 11 and the pressure P2 of the ozone gas are kept higher than the pressure P0 of the pure water which is supplied to the liquid mixing section 12.

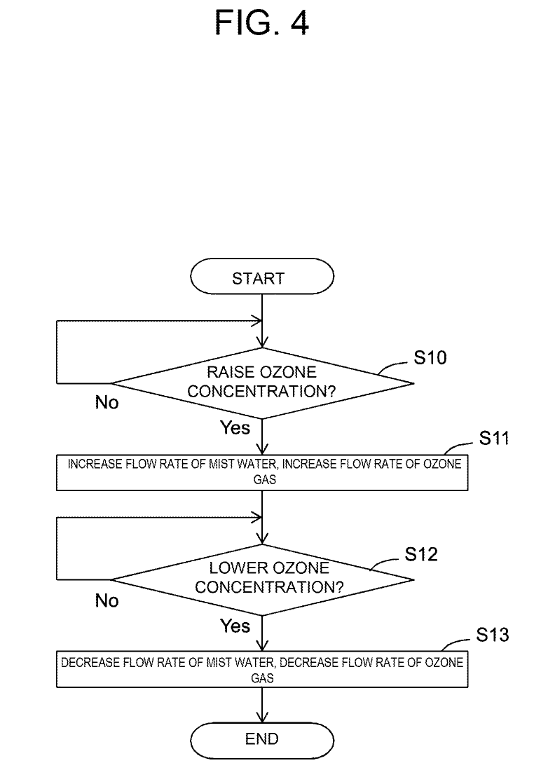

FIG. 4 is a flowchart explaining an operation at a time of adjusting an ozone concentration of the ozone water which is a supply liquid in the gas solution production apparatus 1 of the present embodiment. As illustrated in FIG. 4, when an operation of raising the concentration of the ozone water is performed in the gas solution production apparatus 1 (S10), a flow rate of the pure water that is supplied from the mist water supply unit 2 is increased, and the flow rate of the ozone gas that is supplied from the ozone gas supply unit 4 is increased (S11). When an operation of lowering the concentration of the ozone water is performed (S12), the flow rate of the pure water which is supplied from the mist water supply unit 2 is decreased, and the flow rate of the ozone gas which is supplied from the ozone gas supply unit 4 is decreased (S13). In this way, the pressure P1 of the pure water which is supplied to the mist mixing section 11 and the pressure P2 of the ozone gas are kept higher than the pressure P0 of the pure water which is supplied to the liquid mixing section 12.

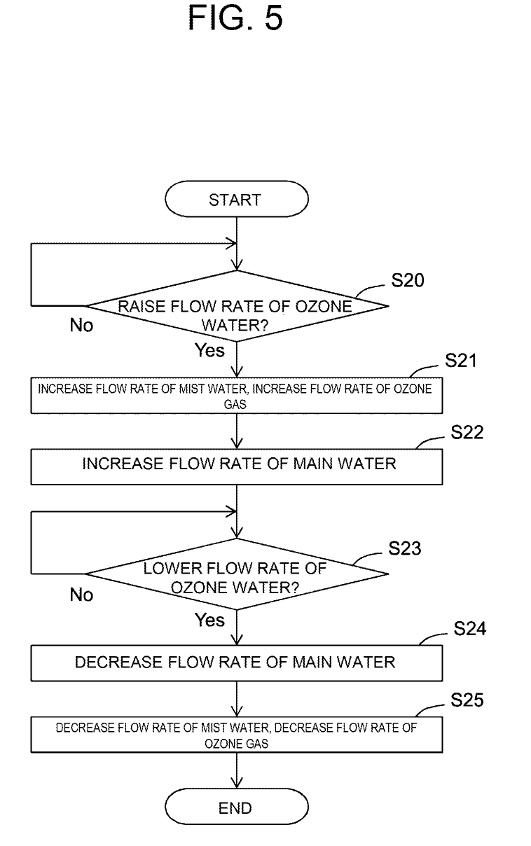

FIG. 5 is a flowchart explaining an operation at a time of adjusting a flow rate of ozone water which is a supply liquid in the gas solution production apparatus 1 of the present embodiment. As illustrated in FIG. 5, when the operation of raising the flow rate of the ozone water is performed in the gas solution production apparatus 1 (820), the pressure P1 at which the pure water is supplied from the mist water supply unit 2 is increased to increase the flow rate, and the pressure P2 at which the ozone gas is supplied from the ozone gas supply unit 4 is increased to increase the flow rate (S21), after which, the flow rate of the pure water which is supplied from the main water supply unit 3 is increased (S22). When the operation of lowering the flow rate of the ozone water is performed (S23), the flow rate of the pure water which is supplied from the main water supply unit 3 is decreased (S24), after which, the flow rate of the pure water which is supplied from the mist water supply unit 2 is decreased, and the flow rate of the ozone gas which is supplied from the ozone gas supply unit 4 is decreased (S25). In this way, the pressure P1 of the pure water which is supplied to the mist mixing section 11 and the pressure P2 of the ozone gas are kept higher than the pressure P0 of the pure water which is supplied to the liquid mixing section 12.

According to the gas solution production apparatus 1 of the present embodiment like this, when ozone water is generated by dissolving the ozone gas into the pure water, the pure water is atomized (atomized into fine particles in a mist form) and is mixed with the ozone gas. Thereby, a dissolution efficiency at the time of ozone gas being dissolved into the pure water can be enhanced, and generation of ozone water can be efficiently performed.

Further, in the present embodiment, when ozone water is generated by dissolving ozone gas into the atomized pure water, the ozone gas is rectified and is mixed with pure water (atomized pure water). Thereby, the dissolution efficiency at the time of the ozone gas being dissolved into pure water can be enhanced, and generation of ozone water can be efficiently performed.

Further, in the present embodiment, the pure water (atomized pure water) and ozone gas are supplied from the first nozzle 9 and the second nozzle 10 which are disposed to face each other, so that pure water (atomized pure water) and ozone gas are efficiently mixed. Thereby, the dissolution efficiency at the time of the ozone gas being dissolved into the pure water can be enhanced, and generation of ozone water can be efficiently performed.

Further, in the present embodiment, the ozone water which is generated in the mist mixing section 11 is supplied to the liquid mixing section 12 via the opening 14 of the connection section 13. In this case, the diameter of the opening 14 of the connection section 13 is 10 mm or less, so that the ozone water which is supplied to the liquid mixing section 12 hardly flows back to the mist mixing section 11 from the liquid mixing section 12 via the opening 14 of the connection section 13. Thereby, the ozone water which is supplied to the liquid mixing section 12 can be prevented from flowing back to the mist mixing section 11 from the liquid mixing section 12.

Further, in the present embodiment, the connection section 13 has the shape (a funnel shape) in which the diameter gradually becomes smaller toward the opening 14, so that the ozone water which is supplied to the liquid mixing section 12 hardly flows back to the mist mixing section 11 from the liquid mixing section 12 via the connection section 13 (the diameter gradually becomes larger as seen from the opening 14). Thereby, the ozone water which is supplied to the liquid mixing section 12 can be prevented from flowing back to the mist mixing section 11 from the liquid mixing section 12.

Further, in the present embodiment, a pressure inside the mist mixing section 11 (the pressures of the pure water and the ozone gas that are supplied to the mist mixing section 11) is higher than a pressure inside the liquid mixing section 12 (the pressure of the pure water that is supplied to the liquid mixing section 12), so that backflow hardly occurs to the mist mixing section 11 from the liquid mixing section 12. Thereby, the ozone water which is supplied to the liquid mixing section 12 can be prevented from flowing back to the mist mixing section 11 from the liquid mixing section 12.

Note that when the gas solution production apparatus is an ozone water generation apparatus, an ozone detection unit not illustrated that detects an ozone concentration in a casing and a control unit may be provided inside the casing not illustrated. The ozone detection unit is electrically connected to the control unit (not illustrated). Thereby, even if leakage of ozone occurs, the leakage can be detected early, and safety of the apparatus can be enhanced.

The embodiment of the present invention is described thus far by illustration, but the range of the present invention is not limited thereby, and the present invention can be modified and changed in accordance with an object within the range described in the claims.

For example, in the above explanation, the case where the liquid of the first raw material is pure water and the gas of the second raw material is ozone gas is described, but it is possible to carry out the present invention similarly even with use of a liquid (for example, sulfuric acid or the like) other than pure water as the liquid of the first raw material, and even with use of gas (for example, hydrogen, nitrogen, carbon dioxide, oxygen, argon, xenon or the like) other than ozone gas as the gas of the second raw material. Alternatively, for example, in order to supply a plurality of supply liquids to one use point, a plurality of gas solution production apparatuses may be installed in one site. Thereby, for example, in order to remove floating metals and organic fine particles from substrates, ozone-containing water and hydrogenated water can be also used in the same use point.

As above, the gas solution production apparatus according to the present invention has an effect of being able to enhance the dissolution efficiency at the time of dissolving the gas of the second raw material into the liquid of the first raw material, and is useful as the ozone water production apparatus or the like for use in cleaning of semiconductor devices, liquid crystal electronic components, and the like.

### REFERENCE SIGNS LIST

1 Gas solution production apparatus
2 Mist water supply unit
3 Main water supply unit
4 Ozone gas supply unit
5 Gas dissolving unit
6 Use point
7 Exhaust port
8 Gas-liquid separation unit
9 First nozzle
10 Second nozzle
11 Mist mixing section
12 Liquid mixing section
13 Connection section
14 Opening

What is claimed is:

1. A gas solution production apparatus, comprising:
a gas dissolving unit that dissolves a gas of a second raw material into a liquid of a first raw material to generate a gas solution with a predetermined concentration; and
a gas-liquid separation unit that subjects the gas solution generated by the gas dissolving unit to gas-liquid separation into a supply liquid that is supplied to a use point, and an exhaust gas that is discharged from an exhaust port,
wherein the gas dissolving unit comprises
a first nozzle that atomizes the liquid of the first raw material,
a mist mixing section that mixes the liquid of the first raw material which is atomized by the first nozzle and the gas of the second raw material, and generates a gas solution with a higher concentration than the predetermined concentration, and
a liquid mixing section that mixes the gas solution with the high concentration generated by the mist mixing section and the liquid of the first raw material, and generates the gas solution with the predetermined concentration.

2. The gas solution production apparatus according to claim 1,
wherein the gas dissolving section comprises a second nozzle that rectifies the gas of the second raw material to supply the gas of the second raw material to the mist mixing section, and
in the mist mixing section, the liquid of the first raw material which is atomized by the first nozzle, and the gas of the second raw material which is rectified by the second nozzle are mixed, and the gas solution with the high concentration is generated.

3. The gas solution production apparatus according to claim 2,
wherein in the mist mixing section, the first nozzle and the second nozzle are disposed to face each other.

4. The gas solution production apparatus according to claim 1,
wherein the mist mixing section comprises a connection section having an opening,
the gas solution generated in the mist mixing section is supplied to the liquid mixing section via the opening, and
a diameter of the opening is 10 mm or less.

5. The gas solution production apparatus according to claim 4,
wherein the connection section has a shape in which a diameter gradually becomes smaller toward the opening.

6. The gas solution production apparatus according to claim 1,
wherein pressures of the liquid of the first raw material and the gas of the second raw material that are supplied to the mist mixing section are set to be higher than a pressure of the liquid of the first raw material that is supplied to the liquid mixing section.

7. The gas solution production apparatus according to claim 1,
wherein the liquid of the first raw material is pure water or sulfuric acid, and the gas of the second raw material is any one of ozone, hydrogen, nitrogen, carbon dioxide, oxygen, argon, and xenon, or a gas composed of a combination of ozone, hydrogen, nitrogen, carbon dioxide, oxygen, argon, and xenon.
